(19) United States
(12) Patent Application Publication
(10) Pub. No.: US 2024/0209288 A1
(43) Pub. Date: Jun. 27, 2024

(54) CLEANING PRODUCT

(71) Applicant: The Procter & Gamble Company, Cincinnati, OH (US)

(72) Inventor: Gregory Leo JERVIER, Cincinnati, OH (US)

(21) Appl. No.: 18/538,264

(22) Filed: Dec. 13, 2023

Related U.S. Application Data
(60) Provisional application No. 63/434,271, filed on Dec. 21, 2022.

(51) Int. Cl. C11D 1/825; C11D 1/66; C11D 3/20

(52) U.S. Cl. CPC C11D 1/8255; C11D 1/662; C11D 3/2082; C11D 2111/14; C11D 2111/44

(57) ABSTRACT

A cleaning composition includes from 2 to 20 wt. % of a surfactant system by weight of the cleaning composition and from 0.1 to 10 wt. % of an alpha hydroxy acid by weight of the cleaning composition. The surfactant system includes alkyl polyglucoside surfactant, a co-surfactant including an ethoxylated alcohol, and less than 3 wt. % of anionic surfactant by weight of the cleaning composition. The pH of the cleaning composition is less than 6.

### TECHNICAL FIELD

The present disclosure relates to a cleaning product comprising a spray dispenser and a cleaning composition, which provides grease cleaning and sudsing performance despite a strongly acidic product pH. The strongly acidic product pH enables strong bacterial kill performance.

### BACKGROUND

Traditionally manual dishwashing has been performed by filling a sink with water, adding a dishwashing detergent to create a soapy solution, immersing the soiled articles in the solution, scrubbing the articles and rinsing to remove the remaining soils and remove the suds generated from the soapy solution from the washed articles. Traditionally an entire load of soiled dishware has usually been washed in one go. Nowadays some users prefer to clean articles as soon as they have finished with them rather than wait until they have a full load. This involves washing one article or a small number of articles at the time. This washing (“wash as you go”) is usually performed under running water rather than in a full sink. The cleaning should be fast and involve minimum effort from the user. In such washing under the tap, the user typically delivers detergent to a sponge.

### SUMMARY

Delivering detergent to a sponge may have the disadvantage of often dosing more detergent than is actually needed, especially when there are only a few items to be washed. Moreover, excessive amounts of detergent require more water and more time to rinse. From a sustainability standpoint, it would be beneficial to reduce the amount of water utilized and/or needed to perform the wash as you go operation.

The use of an antibacterial (AB) cleaning product comprising a spray dispenser and a cleaning composition can alleviate such problems. This may be accomplished by adding an AB active to a traditionally alkaline formulation. Alternatively, an acidic formulation not requiring a dedicated active could also be formulated. However, a challenge with such acidic formulations is to provide a good balance of delivering a sufficient grease cleaning benefit and sudsing performance including initial suds and suds mileage which are acceptable to consumers.

It has now surprisingly been found that a cleaning composition as described by the present disclosure delivers strong AB performance, good sudsing and acceptable grease cleaning performance despite being formulated at an acidic pH. However, it remains challenging to formulate a cleaning composition for a spray product which gives both good initial sudsing after spraying and cleans greasy soils. Initial sudsing, often referred to as “flash” sudsing, is important to give users the connotation of good cleaning efficacy. Beyond the initial or flash sudsing, it is desirable to maintain suds or foam during the washing process, for example, to maintain foam on a cleaning implement, such as a sponge, as such maintained foam connotes the continued effectiveness of the product, without the need for re-dosing. Some consumers may re-dose product when the amount of foam decreases below a certain threshold amount. Re-dosing tends to reduce the efficiency of the overall washing process (and increase the washing time) and may also contribute to over consumption of product as well as over consumption of water in rinsing. It is contemplated that the foaming of the cleaning product of the present disclosure may be tuned by adjusting the ratio of alkyl polyglucoside (APG) to alcohol ethoxylate nonionic surfactant (i.e., less APG may result in less foaming).

A particularly challenging greasy soil to remove is crystalline grease, such as grease which is solid at room temperature such as animal fats, and the like. Typically, good removal of such crystalline grease has required higher levels of detergent composition applied for longer durations, e.g. soaking the dishware with the detergent, in order to soften the crystalline grease to aid removal. However, the need for such soaking time leads to more time needed to wash the dishes, and hence, less satisfied users. Sometimes crystalline grease removal is addressed by formulating (highly) alkaline cleaning compositions, however, it is more challenging to formulate AB efficacy in the absence of a dedicated AB active. Additionally, it is also challenging to solubilize perfume within low surfactant active spray formulations, impacting perfume scent delivery to consumers accordingly.

Hence, a need remains for a cleaning product comprising a spray dispenser and a cleaning composition, which provides strong AB performance, good sudsing, good perfume solubilization and consumer acceptable grease cleaning performance despite being formulated at an acidic pH.

It has surprisingly been found that a composition according to the present disclosure may address this need even without the inclusion of an AB active as is typically provided for its alkaline counterparts.

The present disclosure relates to a cleaning product including a spray dispenser and a cleaning composition housed in the spray dispenser. In one example, the cleaning composition includes from 2 to 20 wt. % of a surfactant system by weight of the cleaning composition and from 0.1 to 10 wt. % of an alpha hydroxy acid by weight of the cleaning composition. The surfactant system includes alkyl polyglucoside surfactant, a co-surfactant including an ethoxylated alcohol, and less than 3 wt. % of anionic surfactant by weight of the cleaning composition. The pH of the cleaning composition is less than 6. Cleaning products of the present disclosure may be free of or substantially free of an AB active. Additionally, products of the present disclosure may comprise or consist essentially of constituents which are considered suitable for contact with surfaces upon which food is prepared or placed.

The present disclosure further relates to a method of cleaning soiled dishware using the product according to the present disclosure including the steps of: optionally pre-wetting the soiled dishware; spraying the cleaning composition onto the soiled dishware; optionally scrubbing the dishware; and rinsing the dishware.

### DETAILED DESCRIPTION

Features and benefits of the various embodiments of the present disclosure will become apparent from the following description, which includes examples of specific embodiments intended to give a broad representation of the disclosure. Various modifications will be apparent to those skilled in the art from this description and from practice of the disclosure. The scope is not intended to be limited to the particular forms disclosed and the disclosure covers all modifications, equivalents, and alternatives falling within the spirit and scope of the disclosure as defined by the claims.

The term “dishware” as used herein includes cookware and tableware made from, by nonlimiting examples, ceramic, china, metal, glass, plastic (e.g., polyethylene, polypropylene, polystyrene, etc.) and wood.

The term “grease” or “greasy” as used herein means materials comprising at least in part (i.e., at least 0.5 wt % by weight of the grease) saturated and unsaturated fats and oils, preferably oils and fats derived from animal sources such as beef, pig and/or chicken.

“Geologically derived” means derived from, for example, petrochemicals, natural gas, or coal. “Geologically derived” materials cannot be easily replenished or regrown (e.g., in contrast to plant- or algae-produced materials).

The term “particulate soils” as used herein means inorganic and especially organic, solid soil particles, especially food particles, such as for non-limiting examples: finely divided elemental carbon, baked grease particle, and meat particles.

The term “sudsing profile” as used herein refers to the properties of a cleaning composition relating to suds character during the dishwashing process. The term “sudsing profile” of a cleaning composition includes suds volume generated upon dissolving and agitation, typically manual agitation, of the cleaning composition in the aqueous washing solution, and the retention of the suds during the dishwashing process. Preferably, hand dishwashing cleaning compositions characterized as having “good sudsing profile” tend to have high suds volume and/or sustained suds volume, particularly during a substantial portion of or for the entire manual dishwashing process. This is important as the consumer uses high suds as an indicator that sufficient cleaning composition has been dosed. Moreover, the consumer also uses the sustained suds volume as an indicator that sufficient active cleaning ingredients (e.g., surfactants) are present, even towards the end of the dishwashing process. The consumer usually renews the washing solution when the sudsing subsides. Thus, a low sudsing cleaning composition will tend to be replaced by the consumer more frequently than is necessary because of the low sudsing level.

As used herein, the term “renewable component” refers to a component that is derived from renewable feedstock and contains renewable carbon. A renewable feedstock is a feedstock that is derived from a renewable resource, e.g., plants, and non-geologically derived. A material may be partially renewable (less than 100% renewable carbon content, from about 1% to about 90% renewable carbon content, or from about 1% to about 80% renewable carbon content, or from about 1% to about 60% renewable carbon content, or from about 1% to about 50% renewable carbon content) or 100% renewable (100% renewable carbon content). A renewable feedstock may be blended or chemically reacted with a geologically derived feedstock, recruiting in a material with a renewable component and a geologically derived component.

“Renewable carbon” may be assessed using the “Assessment of the Biobased Content of Materials” method, ASTM D6866-16.

As used herein, the term “natural oils” means oils that are derived from plant or algae matter (also referred to as renewable oils). Natural oils are not based on kerosene or other fossil fuels. The term “oils” include fats, fatty acids, waste fats, oils, or mixtures thereof. Natural oils include, but are not limited to, coconut oil, babassu oil, castor oil, algae byproduct, beef tallow oil, borage oil, camelina oil, Canola® oil, choice white grease, coffee oil, corn oil, Cuphea viscosissima oil, evening primrose oil, fish oil, hemp oil, hepar oil, jatropha oil, Lesquerella fendleri oil, linseed oil, Moringa Oleifera oil, mustard oil, neem oil, palm oil, perilla seed oil, poultry fat, rice bran oil, soybean oil, stillingia oil, sunflower oil, tung oil, yellow grease, cooking oil, and other vegetable, nut, or seed oils. A natural oil typically includes triglycerides, free fatty acids, or a combination of triglycerides and free fatty acids, and other trace compounds.

The term “substantially free of” or “substantially free from” as used herein refers to either the complete absence of an ingredient or a minimal amount thereof merely as impurity or unintended byproduct of another ingredient. A composition that is “substantially free” of/from a component means that the composition comprises less than about 0.5%, less than about 0.25%, less than about 0.1%, less than about 0.05%, or less than about 0.01% by weight of the composition, of the component.

As used herein the term “dye” includes aesthetic dyes that modify the aesthetics of the cleaning composition as well as dyes and/or pigments that can deposit onto a dishware and alter the tint of the dishware. Dyes include colorants, pigments, and hueing agents.

Unless otherwise noted, all component or composition levels are in reference to the active portion of that component or composition, and are exclusive of impurities, for example, residual solvents or by-products, which may be present in commercially available sources of such components or compositions.

All percentages and ratios are calculated by weight unless otherwise indicated. All percentages and ratios are calculated based on the total composition unless otherwise indicated. It should be understood that every maximum numerical limitation given throughout this specification includes every lower numerical limitation, as if such lower numerical limitations were expressly written herein. Every minimum numerical limitation given throughout this specification will include every higher numerical limitation, as if such higher numerical limitations were expressly written herein. Every numerical range given throughout this specification will include every narrower numerical range that falls within such broader numerical range, as if such narrower numerical ranges were all expressly written herein.

### Cleaning Product

The present disclosure relates to a cleaning product, which is a hand dishwashing cleaning product, the product including a spray dispenser and a cleaning composition. The cleaning composition is included within the spray dispenser.

By “spray dispenser” is herein meant a container including a housing to accommodate the composition and means to spray that composition. The preferred spraying means being a trigger spray. The composition of use in the present disclosure foams when it is sprayed on the surface to be treated.

The need for a cleaning product including a spray dispenser and a cleaning composition, which provides improved suds stability while still delivering crystalline grease cleaning and good initial sudsing is met by formulating the cleaning composition having a pH of less than 6 and having from 2 to 20 weight percent (wt. %) of a surfactant system including an alkyl polyglucoside surfactant, a co-surfactant including an ethoxylated alcohol, and less than 3 wt. % of anionic surfactant by weight of the cleaning composition. The cleaning composition further includes from 0.1 to 10 wt. % of an alpha hydroxy acid by weight of the cleaning composition. The composition may additionally be substantially free of amphoteric surfactants, zwitterionic surfactants, cationic surfactants, or combinations thereof. The cleaning composition includes from 2 to 20 wt. % of a surfactant system by weight of the cleaning composition.

Such cleaning compositions have been found to improve suds stability, as well as softening of crystalline grease (and hence aid its removal from the dish article being treated). Moreover, since the detergent composition is included in a spray container, the composition can be uniformly applied to the surface of the article and left for a period in order to further loosen crystalline grease, as part of a pretreatment step before the main cleaning step. The surfactant system disclosed herein, may include an alkyl polyglucoside surfactant in combination with a co-surfactant including ethoxylated alcohol, has also been found to provide good initial sudsing. It is believed that limiting the amount of, or even more preferably avoiding, anionic surfactant improves initial sudsing, since anionic, amphoteric, and/or zwitterionic surfactants may result in the formation of strong surfactant micelles, thereby inhibiting initial suds formation. Additionally, it is contemplated that anionic surfactants are sensitive to water hardness which means it is more difficult to deliver a consistent product performance across varying water hardness conditions.

The cleaning compositions of the present disclosure may be free of or substantially free of organic solvents and volatile organic compounds. Additional compounds of which the cleaning compositions or the present disclosure may be free of or substantially free of are described herein.

As noted previously, it may be desirable for all the compounds within the cleaning compositions of the present disclosure to be selected in accordance with the Environmental Protection Agency guidelines under C.F.R. § 180.940(a) governing the use of certain active and inert ingredients in antimicrobial compositions which come into contact with food or surfaces upon which food may be placed.

### Cleaning Composition:

The cleaning composition is preferably a hand dishwashing cleaning composition, preferably in liquid form. The cleaning composition is suitable for spraying.

As previously stated, the cleaning composition has a neat (e.g. measured at the full product concentration without creating any dilution) pH of less than about 6. The cleaning composition may have a pH of less than 5, less than 4, less than 3, or less than 2. The cleaning composition may have a pH ranging from 1 to 6, from 1 to 5, from 1 to 4, from 1 to 3, from 1 to 2, from 2 to 6, from 2 to 5, from 2 to 4, from 2 to 3, from 3 to 6, from 3 to 5, from 3 to 4, from 4 to 6, from 4 to 5, from 5 to 6, or any values within the foregoing ranges or any ranges created thereby. Preferably, the cleaning composition has a pH ranging from 1 to 4, and most preferably from 2 to 3. Formulating the composition at this select pH range has been found to strongly improve AB performance.

The cleaning product may include a composition having a Newtonian viscosity, such as from 1 to 50 milliPascal seconds (mPa·s, where 1 mPa·s=1 centiPoise (cP)), preferably from 1 to 20 mPa·s, more preferably from 1 to 10 mPa·s, or any values within the foregoing ranges or any ranges created thereby, at 20° C. as measured using the method defined herein. Preferably the cleaning composition has a Newtonian viscosity.

Alternatively the cleaning product may include a composition having a shear thinning rheology profile, such as having a high shear viscosity of from 1 mPa·s to 50 mPa·s, preferably from 1 mPa·s to 20 mPa·s, more preferably from 5 mPa·s to 15 mPa·s, when measured at a shear rate of at 1000 s⁻¹ at 20° C., and a low shear viscosity of from 100 mPa·s to 1,000 mPa·s, preferably from 200 mPa·s to 500 mPa·s, or any values within the foregoing ranges or any ranges created thereby, when measured at 0.1 s⁻¹ at 20° C., using the method defined herein.

The liquid cleaning composition typically includes an aqueous carrier in which all the other composition actives are dissolved or eventually dispersed. As such, water can be present in an amount of from 60 to 90 wt. %, preferably from 70 to 85 wt. %, or any values within the foregoing ranges or any ranges created thereby, by weight of the cleaning composition.

### Surfactant System:

As previously stated, the cleaning composition includes from 2 to 20 wt. % of a surfactant system by weight of the cleaning composition. The cleaning composition may include from 2 to 20 wt. %, from 3 to 20 wt. %, from 2 to 15 wt. %, from 3 to 15 wt. %, from 2 to 10 wt. %, from 3 to 10 wt. %, from 2 to 8 wt. %, from 3 to 8 wt. %, from 2 to 6 wt. %, from 3 to 6 wt. %, or any values within the foregoing ranges or any ranges created thereby, of the surfactant system by weight of the cleaning composition. The cleaning composition preferably includes from 2% to 15%, more preferably from 3% to 10% of the surfactant system by weight of the cleaning composition.

As previously disclosed, the surfactant system may include an alkyl polyglucoside (APG) surfactant and a co-surfactant comprising an ethoxylated alcohol. The surfactant system may include from 0.5 to 10 wt. %, from 1 to 10 wt. %, from 0.5 to 8 wt. %, from 1 to 8 wt. %, from 0.5 to 6 wt. %, from 1 to 6 wt. %, from 0.5 to 5 wt. %, from 1 to 5 wt. %, from 2 to 10 wt. %, from 2 to 9 wt. %, from 2 to 7 wt. %, from 4 to 10 wt. %, from 4 to 8 wt. %, from 4 to 7 wt. %, from 3 to 10 wt. %, from 3 to 9 wt. %, from 3 to 7 wt. %, or any values within the foregoing ranges or any ranges created thereby, APG surfactant by weight of the composition. The surfactant system preferably includes the APG surfactant at a level of from 0.5 to 10 wt. %, preferably from 1 to 8 wt. %, most preferably from 1 to 5 wt. %, by weight of the composition.

For improved crystalline grease removal, the alkyl polyglucoside surfactant can have a number average alkyl carbon chain length between 8 and 18, or between 8 and 16, preferably between 10 and 16, most preferably between 12 and 14, with an average degree of polymerization of between 0.1 and 3.0 preferably between 1.0 and 2.0, most preferably between 1.2 and 1.6. Preferably the alkyl polyglucoside surfactant includes a C8-C18 alkyl chain distribution, more preferably a dominant C12-C14 alkyl chain length distribution. Most preferably, for improved crystalline grease cleaning, the alkyl polyglucoside surfactant is a mid-cut hence dominant C12-C14 alkyl chain alkyl polyglucoside surfactant with a number average alkyl carbon chain length between 12 and 14 and an average degree of polymerization of between 1.2 and 1.6.

For improved initial sudsing, the alkyl polyglucoside surfactant can have a number average alkyl carbon chain length between 8 and 18, preferably between 8 and 14, most preferably between 8 and 10, with an average degree of polymerization of between 0.1 and 3.0 preferably between 1.0 and 2.0, most preferably between 1.2 and 1.6. Preferably the alkyl polyglucoside surfactant includes a C8-C16 alkyl chain distribution, more preferably a dominant C8-C10 alkyl chain length distribution. Most preferably, for improved initial sudsing, the alkyl polyglucoside surfactant is a low-cut hence dominant C8-C10 alkyl chain alkyl polyglucoside surfactant with a number average alkyl carbon chain length between 8 and 10 and an average degree of polymerization of between 1.2 and 1.6.

It is believed that lower carbon chain lengths can beneficially impact initial sudsing as mentioned previously. Longer carbon chain lengths are believed to have slower kinetics and therefore not create the initial sudsing that consumers may desire. However, the longer carbon chain lengths are believed to have a higher affinity for grease. Additionally, longer carbon chain lengths can increase viscosity making spraying of the composition more difficult.

Similarly, it is believed that the degree of polymerization also impacts the effectiveness of the alklyl polyglucoside. For example, it is believed that if the degree of polymerization is too low, then the alkyl polyglucoside will be too hydrophobic and will not be able to solubilize within the composition. In such instances, the composition may have a phase split between constituent chemistries. This can be highly undesirable by consumers. However, if the degree of polymerization is too high, then alkyl polyglucoside may be too soluble and prefer to stay in the liquid phase even when sprayed and thereby negatively impact initial sudsing.

Low-cut and mid-cut alcohols, used as starting materials in the respective low-cut and mid-cut alkyl polyglucoside production, can be achieved through fractionation of the respective targeted alcohol chain lengths out of the broad natural C8 to C18 alcohol chain length distribution.

C8-C18 alkyl polyglucosides are commercially available from several suppliers (e.g., Simusol® surfactants from Seppic Corporation; and Glucopon® 215 UP, Glucopon® 420 UP, Glucopon® 600 CSUP, Glucopon® 650 EC, Glucopon® 600 CSUP/MB, and Glucopon® 650 EC/MB, from BASF Corporation).

The surfactant system may include from 0.5 to 10 wt. %, from 1 to 10 wt. %, from 0.5 to 8 wt. %, from 1 to 8 wt. %, from 0.5 to 6 wt. %, from 1 to 6 wt. %, from 0.5 to 5 wt. %, from 1 to 5 wt. %, from 2 to 10 wt. %, from 2 to 9 wt. %, from 2 to 7 wt. %, from 4 to 10 wt. %, from 4 to 8 wt. %, from 4 to 7 wt. %, from 3 to 10 wt. %, from 3 to 9 wt. %, from 3 to 7 wt. %, or any values within the foregoing ranges or any ranges created thereby, ethoxylated co-surfactant by weight of the composition. The surfactant system preferably includes the ethoxylated alcohol co-surfactant at a level of from 0.5 to 10 wt. %, preferably from 1 to 8 wt. %, most preferably from 1 to 5 wt. %, by weight of the composition.

The co-surfactant may include alkyl alkoxylated non-ionic surfactants, fatty alcohol polyglycol ethers, fatty acid glucamides, and mixtures thereof, more preferably ethoxylated non-ionic surfactants. Suitable nonionic surfactants include the condensation products of aliphatic alcohols with from 1 to 25 moles of ethylene oxide. The alkyl chain of the aliphatic alcohol can either be straight or branched, primary or secondary, preferably straight.

The co-surfactant includes preferably a low-cut alkyl ethoxylate surfactant. Low-cut alcohol ethoxylate surfactants include alcohol ethoxylate surfactants with a number average alkyl carbon chain length of C10 and below. The ethoxylated alcohol may have a number average alkyl chain length of C1 to C10, C1 to C8, C1 to C7, C1 to C6, from C2 to C10, from C2 to C8, from C2 to C7, from C2 to C6, from C4 to C10, from C4 to C8, from C4 to C7, from C4 to C6, from C5 to C10, from C5 to C8, from C5 to C7, from C5 to C6, or any values within the foregoing ranges or any ranges created thereby. The ethoxylated alcohol may have a number average degree of ethoxylation from 1 to 10, from 1 to 8, from 1 to 7, from 1 to 6, from 1 to 5, from 2 to 10, from 2 to 8, from 2 to 7, from 2 to 6, from 2 to 5, from 4 to 10, from 4 to 8, from 4 to 7, from 4 to 6, from 5 to 10, from 5 to 8, from 5 to 7, from 5 to 6, or any values within the foregoing ranges or any ranges created thereby. More preferably the alkyl ethoxylate surfactant has a number average alkyl chain length of between C5 to C8, preferably between C5 to C7, and a number average degree of ethoxylation of from 1 to 10, preferably from 3 to 8, more preferably from 4 to 6. Most preferably, the co-surfactant includes linear hexyl ethoxylate having a number average degree of ethoxylation ranging from 5 to 6.

Such shorter alkyl chain lengths and average degree of ethoxylation have been found to be beneficial to boost foaming profile, contrary to their longer chain analogues. Beyond improved perfume solubilization has been found when formulating alcohol ethoxylate nonionic surfactants.

Suitable non-ionic alcohol ethoxylate surfactants include commercially available materials such as Emulan® HE50 or Lutensol® CS6250 (available from BASF). It is contemplated that the co-surfactant may consist of the ethoxylated alcohol, more preferably the co-surfactant may consist of the alkyl ethoxylate surfactant has a number average alkyl chain length of C5 to C7, and a number average degree of ethoxylation from 4 to 6, most preferably the co-surfactant may consist of linear hexyl ethoxylate having a number average degree of ethoxylation ranging from 5 to 6.

The alkyl polyglucoside surfactant and the co-surfactant may be present at a weight ratio of from about 10:1 to about 1:2, preferably from about 8:1 to about 1:1, most preferably from about 3:1 to about 1.25:1, or any values within the foregoing ranges or any ranges created thereby.

The surfactant system includes less than 3% by weight of the liquid detergent composition of an anionic surfactant, preferably less than 2%, more preferably from 0.01 to 1 wt. %. Alternatively, the surfactant system may be free of anionic surfactant. When present the anionic surfactant may be selected from unethoxylated alkyl sulphate, ethoxylated alkyl sulphate anionic surfactant, linear alkyl benzene sulphonate anionic surfactant, or mixtures thereof, preferably linear alkyl benzene sulphonate anionic surfactant. Such presence may potentiate the antibacterial product performance as well as positively impact grease cleaning and sudsing.

Most preferably the surfactant system includes or consists essentially of from about 1 to about 5 wt. % alkyl polyglucoside surfactant, preferably having an average alkyl chain length between about 8 and about 18, more preferably between about 8 and about 14, most preferably between about 8 and about 10, and an average degree of polymerization of between about 1.2 and about 1.6, and from about 1 to about 5 wt. % ethoxylated alcohol surfactant, preferably having an average alkyl chain length of between C5 and C7 and a number average degree of ethoxylation of from 4 to 6.

### Anionic Surfactant:

The cleaning composition may include an anionic surfactant. Suitable anionic surfactants include, but are not limited to, those surface-active compounds that contain an organic hydrophobic group containing generally 8 to 22 carbon atoms or generally 8 to 18 carbon atoms in their molecular structure and at least one water-solubilizing group preferably selected from sulfonate, sulfate, and carboxylate so as to form a water-soluble compound. Usually, the hydrophobic group will include a linear or branched C8-C22 alkyl, or acyl group. Such surfactants are employed in the form of water-soluble salts and the salt-forming cation usually is selected from sodium, potassium, ammonium, magnesium and mono-, di- or tri-alkanolammonium, with the sodium, cation being the usual one chosen. The anionic surfactant may preferably include linear alkylbenzene sulphonic acid (HLAS).

The surfactant system may optionally include less than 3 wt. %, preferably less than 2 wt. %, more preferably less than 1 wt. % anionic surfactant by weight of the cleaning composition. The surfactant system may include from 0.01 to 3 wt. %, from 0.01 to 2 wt. %, from 0.01 to 1 wt. %, from 0.01 to 0.5 wt. %, from 0.01 to 0.3 wt. %, from 0.01 to 0.1 wt. %, or any values within the foregoing ranges or any ranges created thereby, of anionic surfactant by weight of the cleaning composition. It is contemplated that the inclusion of the anionic surfactant synergistically interacts with the alpha hydroxy acid to improve performance of the cleaning composition even when the alpha hydroxy acid is present at relatively low concentrations, such as less than 10 wt. %, more preferably less than 8 wt. %, most preferably less than 6 wt. % of an alpha hydroxy acid by weight of the cleaning composition.

### Other Surfactant:

The compositions of use in the present disclosure are preferably free of cationic surfactant and especially free of antimicrobial cationic surfactants, since such surfactants are typically detrimental to grease cleaning and surface shine. Such antimicrobial cationic surfactants include quaternary ammonium compounds such as didodecyl dimethyl ammonium chloride, alkyl dimethyl benzyl ammonium chloride, alkyl dimethyl ethylbenzyl ammonium chloride, and mixtures thereof.

Additionally or alternatively, the compositions of use in the present disclosure can comprise less than 0.5 wt. % by weight of the cleaning composition, preferably are substantially free of amphoteric surfactants, zwitterionic surfactants, or both, especially less than 0.5 wt. % by weight of the cleaning composition, preferably free of amine oxides, betaines, or both.

### Alpha Hydroxy Acid:

As previously stated, the cleaning composition may include from 0.1 to 10 wt. % of an alpha hydroxy acid by weight of the cleaning composition. Suitable alpha hydroxy acids may include lactic acid and citric acid, preferably citric acid.

The cleaning composition may include from 0.1 to 10 wt. %, from 0.1 to 8 wt. %, from 0.1 to 7 wt. %, from 0.1 to 6 wt. %, from 0.1 to 5 wt. %, from 1 to 10 wt. %, from 1 to 8 wt. %, from 1 to 7 wt. %, from 1 to 6 wt. %, from 1 to 5 wt. %, from 2 to 10 wt. %, from 2 to 8 wt. %, from 2 to 7 wt. %, from 2 to 6 wt. %, from 2 to 5 wt. %, from 3 to 10 wt. %, from 3 to 8 wt. %, from 3 to 7 wt. %, from 3 to 6 wt. %, from 3 to 5 wt. %, from 4 to 10 wt. %, from 4 to 8 wt. %, from 4 to 7 wt. %, from 4 to 6 wt. %, from 4 to 5 wt. %, from 5 to 10 wt. %, from 5 to 8 wt. %, from 5 to 7 wt. %, from 5 to 6 wt. %, from 6 to 10 wt. %, from 6 to 8 wt. %, from 6 to 7 wt. %, or any values within the foregoing ranges or any ranges created thereby, preferably from 0.1 to 10 wt. %, or from 1 to 10 wt. %, or from 2 to 8 wt. %, of alpha hydroxy acid by weight of the cleaning composition.

Preferably, the cleaning composition includes greater than 4 wt. %, more preferably greater than 5 wt. %, and most preferably from about 4 to about 6 wt. % of an alpha hydroxy acid by weight of the cleaning composition, the alpha hydroxy acid preferably having a number average alkyl chain length from about 1 to about 10, more preferably from about 3 to about 6, most preferably from about 5 to about 6 carbon atoms.

### Organic Solvent:

For improved penetration and removal of crystalline grease, the composition may optionally include an organic solvent. Suitable organic solvents can be selected from the group consisting of: glycol solvents, glycol ether solvents, alcohol solvents, and combinations thereof.

The surfactant system and the organic solvent may be in a weight ratio of from about 5:1 to about 1:5, preferably from about 4:1 to about 1:2, most preferably about 4:1 to about 1:1. Compositions of use in the present disclosure, having such a weight ratio of surfactant system to organic solvent have been found to provide improved coverage on the dishware with minimum over-spray (residual spray droplets remaining in suspension in the air). Therefore, such spray compositions reduce wastage and minimise the amount of spray droplets which can be inhaled. Compositions having a surfactant:solvent weight ratio lower than about 1:5 have been found to be less foaming and/or have a greater tendency to phase separate over time. Compositions having a surfactant:solvent weight ratio higher than about 5:1 are typically more difficult to spray and are more prone to gelling when sprayed onto greasy soils, when the soil is not first wetted. Such gel formation inhibits the spreading of the composition onto the greasy surface and hence leads to less satisfactory cleaning.

The cleaning composition may include from 0.1 to 10 wt. %, from 0.1 to 9 wt. %, from 0.1 to 8 wt. %, from 0.1 to 6 wt. %, from 0.1 to 5 wt. %, from 0.1 to 3 wt. %, from 0.1 to 1 wt. %, from 1 to 10 wt. %, from 1 to 9 wt. %, from 1 to 8 wt. %, from 1 to 6 wt. %, from 1 to 5 wt. %, from 1 to 3 wt. %, from 3 to 10 wt. %, from 3 to 9 wt. %, from 3 to 8 wt. %, from 3 to 6 wt. %, from 3 to 5 wt. %, from 5 to 10 wt. %, from 5 to 9 wt. %, from 5 to 8 wt. %, from 5 to 6 wt. %, from 6 to 10 wt. %, from 6 to 9 wt. %, from 6 to 8 wt. %, from 8 to 10 wt. %, or any values within the foregoing ranges or any ranges created thereby, of organic solvent by weight of the cleaning composition.

The organic solvent may preferably include glycol solvents. Suitable glycol solvents may include ethyleneglycol, diethyleneglycol, triethyleneglycol, polyethyleneglycol, propyleneglycol, dipropylene glycol (DPG). Tripropyleneglycol, polypropyleneglycol, or a mixture thereof. Preferably the glycol solvent comprises DPG. The DPG may tune the viscosity of the cleaning composition and may reduce overall nasal stinginess of the cleaning composition.

Suitable glycol ether solvents can be selected from the group consisting of:
a) Formula I: R1O(R2O)nR3,
   R1 is a linear or branched C4, C5 or C6 alkyl or a substituted or unsubstituted phenyl, R2 is ethyl or isopropyl, R3 is hydrogen or methyl and n is 1, 2 or 3;
b) Formula II: R4O(R5O)nR6,
   R4 is n-propyl or isopropyl, R5 is isopropyl, R6 is hydrogen or methyl and n is 1, 2 or 3; and
c) mixtures thereof

Suitable alcohol solvents can be selected from the group consisting of: C4-C6 linear mono-alcohols, branched C4-C10 mono-alcohols having one or more C1-C4 branching groups, alkyl mono-glycerols, and mixtures thereof.

The composition may include from 0.1% to 10%, preferably from 1.0% to 8.0%, more preferably from 3.0% to 7.0% by weight of the total composition of the organic solvent.

Suitable glycol ether solvents according to Formula I include ethyleneglycol n-butyl ether, diethyleneglycol n-butyl ether, triethyleneglycol n-butyl ether, propyleneglycol n-butyl ether, dipropyleneglycol n-butyl ether, tripropyleneglycol n-butyl ether, ethyleneglycol n-pentyl ether, diethyleneglycol n-pentyl ether, triethyleneglycol n-pentyl ether, propyleneglycol n-pentyl ether, dipropyleneglycol n-pentyl ether, tripropyleneglycol n-pentyl ether, ethyleneglycol n-hexyl ether, diethyleneglycol n-hexyl ether, triethyleneglycol n-hexyl ether, propyleneglycol n-hexyl ether, dipropyleneglycol n-hexyl ether, tripropyleneglycol n-hexyl ether, ethyleneglycol phenyl ether, diethyleneglycol phenyl ether, triethyleneglycol phenyl ether, propyleneglycol phenyl ether, dipropyleneglycol phenyl ether, tripropyleneglycol phenyl ether, ethyleneglycol benzyl ether, diethyleneglycol benzyl ether, triethyleneglycol benzyl ether, propyleneglycol benzyl ether, dipropyleneglycol benzyl ether, tripropyleneglycol benzyl ether, ethyleneglycol isobutyl ether, diethyleneglycol isobutyl ether, triethyleneglycol isobutyl ether, propyleneglycol isobutyl ether, dipropyleneglycol isobutyl ether, tripropyleneglycol isobutyl ether, ethyleneglycol isopentyl ether, diethyleneglycol isopentyl ether, triethyleneglycol isopentyl ether, propyleneglycol isopentyl ether, dipropyleneglycol isopentyl ether, tripropyleneglycol isopentyl ether, ethyleneglycol isohexyl ether, diethyleneglycol isohexyl ether, triethyleneglycol isohexyl ether, propyleneglycol isohexyl ether, dipropyleneglycol isohexyl ether, tripropyleneglycol isohexyl ether, ethyleneglycol n-butyl methyl ether, diethyleneglycol n-butyl methyl ether triethyleneglycol n-butyl methyl ether, propyleneglycol n-butyl methyl ether, dipropyleneglycol n-butyl methyl ether, tripropyleneglycol n-butyl methyl ether, ethyleneglycol n-pentyl methyl ether, diethyleneglycol n-pentyl methyl ether, triethyleneglycol n-pentyl methyl ether, propyleneglycol n-pentyl methyl ether, dipropyleneglycol n-pentyl methyl ether, tripropyleneglycol n-pentyl methyl ether, ethyleneglycol n-hexyl methyl ether, diethyleneglycol n-hexyl methyl ether, triethyleneglycol n-hexyl methyl ether, propyleneglycol n-hexyl methyl ether, dipropyleneglycol n-hexyl methyl ether, tripropyleneglycol n-hexyl methyl ether, ethyleneglycol phenyl methyl ether, diethyleneglycol phenyl methyl ether, triethyleneglycol phenyl methyl ether, propyleneglycol phenyl methyl ether, dipropyleneglycol phenyl methyl ether, tripropyleneglycol phenyl methyl ether, ethyleneglycol benzyl methyl ether, diethyleneglycol benzyl methyl ether, triethyleneglycol benzyl methyl ether, propyleneglycol benzyl methyl ether, dipropyleneglycol benzyl methyl ether, tripropyleneglycol benzyl methyl ether, ethyleneglycol isobutyl methyl ether, diethyleneglycol isobutyl methyl ether, triethyleneglycol isobutyl methyl ether, propyleneglycol isobutyl methyl ether, dipropyleneglycol isobutyl methyl ether, tripropyleneglycol isobutyl methyl ether, ethyleneglycol isopentyl methyl ether, diethyleneglycol isopentyl methyl ether, triethyleneglycol isopentyl methyl ether, propyleneglycol isopentyl methyl ether, dipropyleneglycol isopentyl methyl ether, tripropyleneglycol isopentyl methyl ether, ethyleneglycol isohexyl methyl ether, diethyleneglycol isohexyl methyl ether, triethyleneglycol isohexyl methyl ether, propyleneglycol isohexyl methyl ether, dipropyleneglycol isohexyl methyl ether, tripropyleneglycol isohexyl methyl ether, and mixtures thereof.

Preferred glycol ether solvents according to Formula I are ethyleneglycol n-butyl ether, diethyleneglycol n-butyl ether, triethyleneglycol n-butyl ether, propyleneglycol n-butyl ether, dipropyleneglycol n-butyl ether, tripropyleneglycol n-butyl ether, and mixtures thereof.

The most preferred glycol ether solvents according to Formula I are propyleneglycol n-butyl ether, dipropyleneglycol n-butyl ether, and mixtures thereof.

Suitable glycol ether solvents according to Formula II include propyleneglycol n-propyl ether, dipropyleneglycol n-propyl ether, tripropyleneglycol n-propyl ether, propyleneglycol isopropyl ether, dipropyleneglycol isopropyl ether, tripropyleneglycol isopropyl ether, propyleneglycol n-propyl methyl ether, dipropyleneglycol n-propyl methyl ether, tripropyleneglycol n-propyl methyl ether, propyleneglycol isopropyl methyl ether, dipropyleneglycol isopropyl methyl ether, tripropyleneglycol isopropyl methyl ether, and mixtures thereof.

Preferred glycol ether solvents according to Formula II are propyleneglycol n-propyl ether, dipropyleneglycol n-propyl ether, and mixtures thereof.

The most preferred glycol ether solvents are propyleneglycol n-butyl ether, dipropyleneglycol n-butyl ether, and mixtures thereof, especially dipropyleneglycol n-butyl ether.

Suitable glycol ether solvents can be purchased from The Dow Chemical Company, in particularly from the E-series (ethylene glycol based) Glycol Ether and the P-series (propylene glycol based) Glycol Ether line-ups. Suitable glycol ether solvents include Butyl Carbitol, Hexyl Carbitol, Butyl Cellosolve, Hexyl Cellosolve, Butoxytriglycol, Dowanol Eph, Dowanol PnP, Dowanol DPnP, Dowanol PnB, Dowanol DPnB, Dowanol TPnB, Dowanol PPh, and mixtures thereof.

Suitable alcohols can be selected from the group consisting of C4-C6 linear mono-alcohols, branched C4-C10 mono-alcohols having one or more C1-C4 branching groups, alkyl mono-glycerols, and mixtures thereof.

Preferred C4-C6 linear mono-alcohols are selected from pentanol, hexanol, and mixtures thereof, preferably 1-pentanol, 1-hexanol, and mixtures thereof.

Preferred branched C4-C10 mono-alcohols having one or more C1-C4 branching groups for use herein are C4-C8 primary mono-alcohols having one or more C1-C4 branching groups, and mixtures thereof. Especially preferred branched C4-C10 mono-alcohols having one or more C1-C4 branching groups for use herein include methyl butanol, ethyl butanol, methyl pentanol, ethyl pentanol, methyl hexanol, ethyl hexanol, propyl hexanol, dimethyl hexanol trimethyl hexanol, methyl hepanol, ethyl heptanol, propyl heptanol, dimethyl heptanol, trimethyl heptanol, methyl octanol, ethyl octanol, propyl octanol, butyl octanol, dimethyl octanol, trimethyl octanol, methyl nonanol, ethyl nonanol, propyl nonanol, butyl nonanol, dimethyl nonanol and trimethyl nonanol, and mixtures thereof. More preferred for use herein are the primary 1-alcohol member of branched C4-C10 mono-alcohols having one or more C1-C4 branching groups, especially preferred are the primary 1-alcohol family members of methyl butanol, ethyl butanol, methyl pentanol, ethyl pentanol, methyl hexanol, ethyl hexanol, propyl hexanol, dimethyl hexanol trimethyl hexanol, methyl hepanol, ethyl heptanol, propyl heptanol, dimethyl heptanol, trimethyl heptanol, methyl octanol, ethyl octanol, propyl octanol, butyl octanol, dimethyl octanol, trimethyl octanol, methyl nonanol, ethyl nonanol, propyl nonanol, butyl nonanol, dimethyl nonanol, trimethyl nonanol, and mixtures thereof.

More preferred alcohols are butyl octanol, trimethyl hexanol, ethyl hexanol, propyl heptanol, methyl butanol, and mixtures thereof, in particular the primary 1-alcohol family member, more in particular ethyl hexanol, butyl octanol, trimethyl hexanol, and mixtures thereof, especially 2-ethyl-1-hexanol, 2-butyl-1-octanol, 3,5,5 trimethyl-1-hexanol, and mixtures thereof.

Preferred alkyl mono-glycerols are selected from the group consisting of branched alkyl mono-glycerols and mixtures thereof, more preferably branched C4-C8 alkyl mono-glycerols with one or more C1 to C4 alkyl branching groups, more preferably selected from the group consisting of ethylhexylglycerol, propylheptylglycerol, and mixtures thereof, most preferably 2-ethylhexylglycerol.

Such alcohols can also improve sudsing.

Especially preferred for use herein are mixtures of mono-alcohols, in particular mixtures including a branched C4-C10 mono-alcohol, more in particular mixtures including an alcohol selected from the group including C4-C8 more preferably C6-C7 branched primary alcohols. Preferably for use is a mixture of alcohols including an alcohol selected from the group including C4-C8 branched primary alcohols with an alcohol selected of the group of C4-C6 linear mono-alcohols and alkylglycerols. Such mixtures can boost foaming and improve cleaning of various oily soils.

### Further Optional Ingredients:

### Acidulant:

The cleaning composition may further include an acidulant. The acidulant may include acetic acid, ascorbic acid, fumaric acid, phosphoric acid, sulfuric acid, or combinations. Preferably, the acidulant includes sulfuric acid. The acidulant may consist of sulfuric acid.

The cleaning composition may include from 0.01 to 1 wt. %, from 0.01 to 0.5 wt. %, from 0.01 to 0.1 wt. %, from 0.01 to 0.07 wt. %, from 0.01 to 0.05 wt. %, more preferably from 0.03 to 0.07 wt. %, most preferably from 0.05 to 0.07 wt. %, or any values within the foregoing ranges or any ranges created thereby, of acidulant by weight of the cleaning composition.

### Alcohol:

The cleaning composition may further include a C1-C3 alcohol, preferably ethanol. The cleaning composition may include from 0.01 to 3 wt. %, from 0.01 to 1 wt. %, from 0.01 to 0.8 wt. %, from 0.01 to 0.6 wt. %, from 0.01 to 0.5 wt. %, from 0.01 to 0.3 wt. %, from 0.1 to 1 wt. %, from 0.1 to 0.8 wt. %, from 0.1 to 0.6 wt. %, from 0.1 to 0.5 wt. %, from 0.1 to 0.3 wt. %, from 0.3 to 1 wt. %, from 0.3 to 0.8 wt. %, from 0.3 to 0.6 wt. %, from 0.3 to 0.5 wt. %, from 0.4 to 1 wt. %, from 0.4 to 0.8 wt. %, from 0.4 to 0.6 wt. %, from 0.4 to 0.5 wt. %, or any values within the foregoing ranges or any ranges created thereby, of alcohol by weight of the cleaning composition.

### Chelant:

The composition herein may optionally further include a chelant at a level of from 0.1% to 10%, preferably from 0.2% to 5%, more preferably from 0.2% to 3%, most preferably from 0.5% to 1.5% by weight of the composition.

Suitable chelating agents can be selected from the group consisting of amino carboxylates, amino phosphonates, polyfunctionally-substituted aromatic chelating agents and mixtures thereof.

Amino carboxylates include ethylenediaminetetra-acetates, N-hydroxyethylethylenediaminetriacetates, nitrilo-triacetates, ethylenediamine tetraproprionates, triethylenetetraaminehexacetates, diethylenetriaminepentaacetates, and ethanoldiglycines, alkali metal, ammonium, and substituted ammonium salts therein and mixtures therein, as well as MGDA (methyl-glycine-diacetic acid), and salts and derivatives thereof and GLDA (glutamic-N,N-diacetic acid) and salts and derivatives thereof. GLDA (salts and derivatives thereof) is especially preferred according to the present disclosure.

### Hydrotropes

The composition according to the present disclosure may further include a hydrotrope. Preferably the hydrotrope is selected from cumene sulphonate, xylene sulphonate, toluene sulphonate, most preferably sodium neutralized cumene sulphonate. When present the hydrotrope is formulated from 0.1% to 5%, preferably from 0.25% to 3%, most preferably from 0.5% to 2% by weight of the detergent composition.

### Shear Thinning Rheology Modifier:

The composition according to the present disclosure may further include a rheology modifying agent, providing a shear thinning rheology profile to the product. Formulating with a rheology modifying polymer can improve particle size distribution of the resultant spray, as well as mitigating any stinging effect of the spray droplets. Preferably the rheology modifying agent is a non crystalline polymeric rheology modifier. This polymeric rheology modifier can be a synthetic or a naturally derived polymer.

Examples of naturally derived polymeric structurants of use in the present disclosure include: hydroxyethyl cellulose, hydrophobically modified hydroxyethyl cellulose, carboxymethyl cellulose, polysaccharide derivatives and mixtures thereof. Polysaccharide derivatives include but are not limited to pectine, alginate, arabinogalactan (gum Arabic), carrageenan, gum karaya, gum tragacanth, gellan gum, xanthan gum and guar gum. Examples of synthetic polymeric structurants of use in the present disclosure include polymers and copolymers including polycarboxylates, polyacrylates, polyurethanes, polyvinylpyrrolidone, polyols and derivatives and mixtures thereof. Additionally or alternatively, the composition of use in the present disclosure may include a polyethylenoxide (PEO) polymer.

Preferably the composition includes a rheology modifying polymer selected from a naturally derived rheology modifying polymer, most preferably Xanthan Gum, a polyethylenoxide, or mixtures thereof.

Generally, the rheology modifying polymer will be included at a level of from 0.001% to 1% by weight, alternatively from 0.01% to 0.5% by weight, more alternatively from 0.05% to 0.25% by weight of the composition.

### Other Ingredients:

The composition herein may include a number of optional ingredients such as rheology trimming agents selected from inorganic salts preferably sodium chloride, C2-C4 alcohols, C2-C4 polyols, poly alkylene glycols and especially polypropyleneglycols having a weight average molecular weight of from 1500 to 4,000, and mixtures thereof.

The composition may also include pH trimming and/or buffering agents such as sodium hydroxyde, hydrochloric acid, (distilled) vinegar, and mixtures thereof, preferably hydrochloric acid, (distilled) vinegar, and mixtures thereof. The composition may further include minor ingredients selected from preservatives, UV stabilizers, antioxidants, perfumes, coloring agents, and mixtures thereof.

### Spray Dispenser:

The spray dispenser includes a reservoir to accommodate the composition of the present disclosure and spraying means. Suitable spray dispensers may include a pump (sometimes referred to as “trigger”) devices. e.g., manually or electrically operated, pressurized can devices, electrostatic spray devices, etc. Preferably the spray dispenser is non-pressurized and the spray means are of the trigger dispensing type. The reservoir is typically a container such as a bottle, more typically a plastic bottle.

The cleaning product includes the cleaning composition. The cleaning composition is typically suitable for spraying from the spray dispenser onto the dish surface to be treated (“direct application”). The composition preferably forms a foam on the surface immediately upon application without requiring any additional physical (e.g., manual rubbing) intervention.

The spray dispenser typically includes a trigger lever which, once depressed, activates a small pump. The main moving element of the pump is typically a piston, housed inside a cylinder, with the piston pressing against a spring. By depressing the trigger, the piston is pushed into the cylinder and against the spring, compressing the spring, and forcing the composition contained within the pump out of a nozzle. Once the trigger lever is released, the spring pushes the piston back out, expanding the cylinder area, and sucking the composition from the reservoir, typically through a one-way valve, and refilling the pump. This pump is typically attached to a tube that draws the composition from the reservoir into the pump. The spray dispenser can include a further one-way valve, situated between the pump and the nozzle.

The nozzle includes an orifice through which the composition is dispensed. The nozzle utilizes the kinetic energy of the composition to break it up into droplets as it passes through the orifice. Suitable nozzles can be plain, or shaped, or include a swirl chamber immediately before the orifice. Such swirl chambers induce a rotary fluid motion to the composition which causes swirling of the composition in the swirl chamber. A film is discharged from the perimeter of the orifice which typically results in dispensing the composition from the orifice as finer droplets.

Since such trigger-activated spray dispensers include a pump, the composition preferably is not pressurized within the reservoir and preferably does not include a propellant.

The spray dispenser can be a pre-compression sprayer which includes a pressurized buffer for the composition, and a pressure-activated one-way valve between the buffer and the spray nozzle. Such precompression sprayers provide a more uniform spray distribution and more uniform spray droplet size since the composition is sprayed at a more uniform pressure. Such pre-compression sprayers include the Flairosol® spray dispenser, manufactured and sold by Afa Dispensing Group (The Netherlands) and the pre-compression trigger sprayers described in U.S. Patent Publication Nos. 2013/0112766 and 2012/0048959.

### Method of Use:

The cleaning products, as described herein, are particularly suited for methods of cleaning dishware including the steps of: optionally pre-wetting the dishware; spraying the cleaning composition onto the dishware; optionally scrubbing the dishware; and rinsing the dishware.

The cleaning products described herein are particularly effective at loosening soils, and especially greasy soils. As such, especially for light soiling, scrubbing is optional, and particularly when the dishware is left for at least 15 seconds, preferably at least 30 seconds after the spray step, before the rinsing step is done.

The steps of scrubbing of the dishware and rinsing the dishware can take place at least partially simultaneously, for example, by scrubbing the dishware under running water or when the dishware is submerged in water. The scrubbing step can take between 1 second and 30 seconds.

The present method allows for faster and easier cleaning of dishware when the dishware is lightly soiled. When the dishware is heavily soiled with tough food soils such as cooked-, baked- or burnt-on soils, the present method facilitates the cleaning when the soiled dishware is soaked with the product of the present disclosure in neat form or diluted in water, preferably for a period of from 1 second to 30 seconds, or longer.

### EXAMPLES

The formulations below (tables 1-3) comprised percentages by weight of the compounds listed. Formulations were prepared on a lab scale through mixing of the individual materials in a batch type process. Additional information regarding each of the compounds is provided below:
C8-C10 Alkyl polyglucoside—Glucopon 215UP available from BASF
C12-14 Alkyl polyglucoside—Glucopon 600CSUP available from BASF
n-C6EO5 Alcohol Ethoxylate non ionic surfactant—Lutensol CS6250 available from BASF
Amine oxide—C12-14 dimethyl amine oxide available from P&G Chemicals
Alkyl ethoxysulfate—sodium laureth 3 sulfate
Alpha hydroxy acid—citric acid

Inventive Example 1 comprises the alkyl polyglucoside—alcohol ethoxylate nonionic surfactant composition, the alpha-hydroxy acid and a strongly acidic pH and as such is a composition according to the invention.

Comparative Example 1 single variably differs from Inventive Example 1 through having an alkaline pH.

Comparative Examples 2 and 3 differ from Inventive Example 1 and Comparative Example 1 through lacking the alcohol ethoxylate nonionic surfactant according to the invention.

Comparative Examples 4 and 5 differ from Inventive Example 1 and Comparative Example 1 through lacking the alkyl polyglucoside nonionic surfactant according to the invention.

Comparative Examples 6 and 7 differ from Inventive Example 1 and Comparative Example 1 through having a longer alkyl chain length for the alkyl polyglucoside nonionic surfactant.

Comparative Examples 8 and 9 describe an alkyl ethoxysulfate—amine oxide—ethoxylated alcohol based surfactant system as it is known in the prior art.

TABLE 1

| | | Com- | Com- | Com- |
|---|---|---|---|---|
| | Inventive | parative | parative | parative |
| | Ex 1 | Ex. 1 | Ex. 2 | Ex. 3 |
| Compounds | (wt %) | (wt %) | (wt %) | (wt %) |
| Alkyl polyglucoside | 9.0 | 9.0 | 9.0 | 9.0 |
| (C8-10) | | | | |
| Alcohol ethoxylate | 6.0 | 6.0 | 0.0 | 0.0 |
| Non ionic | | | | |
| Amine oxide | 0.0 | 0.0 | 0.0 | 0.0 |
| Alkyl ethoxysulfate | 0.0 | 0.0 | 0.0 | 0.0 |
| Alpha hydroxy acid | 5.0 | 5.0 | 5.0 | 5.0 |
| Sodium Hydroxide | 0.35 | 3.0 | 0.20 | 3.0 |
| Sulfuric Acid | 0.0 | 0.0 | 0.0 | 0.0 |
| Perfume | 0.30 | 0.30 | 0.30 | 0.30 |
| water | Balance | Balance | Balance | Balance |
| pH | 2.5 | 10 | 2.5 | 10 |

TABLE 2

| | Com- | Com- | Com- | Com- |
|---|---|---|---|---|
| | parative | parative | parative | parative |
| | Ex. 4 | Ex. 5 | Ex. 6 | Ex. 7 |
| Compounds | (wt %) | (wt %) | (wt %) | (wt %) |
| Lauryl/Myristyl | 0.0 | 0.0 | 4.5 | 4.5 |
| Glucoside (C12-14) | | | | |
| Alcohol ethoxylate | 6.0 | 6.0 | 6.0 | 6.0 |
| Non ionic | | | | |
| C12-14 Amine | 0.0 | 0.0 | 4.5 | 4.5 |
| oxide | | | | |
| Alkyl ethoxysulfate | 0.0 | 0.0 | 0.0 | 0.0 |
| Alpha hydroxy acid | 5.0 | 5.0 | 5.0 | 5.0 |
| Sodium Hydroxide | 0.50 | 3.0 | 0.0 | 3.0 |
| Sulfuric Acid | 0.06 | 0.06 | 0.3 | 0.0 |
| Perfume | 0.30 | 0.30 | 0.30 | 0.30 |
| water | Balance | Balance | Balance | Balance |
| pH | 2.5 | 10 | 2.5 | 10 |

TABLE 3

| | Comparative | Comparative |
|---|---|---|
| Compounds | Ex. 8 (wt %) | Ex. 9 (wt %) |
| Alkyl polyglucoside | 0.0 | 0.0 |
| Alcohol ethoxylate Non ionic | 6.0 | 6.0 |
| Amine oxide | 3.5 | 3.5 |
| Alkyl ethoxysulfate | 5.0 | 5.0 |
| Alpha hydroxy acid | 5.0 | 5.0 |
| Sodium Hydroxide | 0.0 | 3.5 |
| Perfume | 0.30 | 0.30 |
| water | Balance | Balance |
| pH | 2.5 | 10 |

Table 4 summarizes the initial suds volume, remaining suds volume after 10 minutes as well as the antibacterial efficacy of the different test products. From the data it is clear that the alkaline comparative formulations are not suitable to deliver the targeted antibacterial performance properties. Comparative formulations lacking the alkyl polyglucoside surfactant (Comparative Examples 4 and 5) do not deliver the targeted antibacterial nor sudsing performance properties. Replacement of short chain alkyl polyglucoside surfactant by long chain alkyl polyglucoside surfactant (Comparative Examples 6 and 7) equally leads to a compromise on antibacterial product efficacy. Prior art anionic surfactant—amine oxide—alcohol ethoxylate surfactant system also compromises on sudsing and antibacterial product efficacy.

It is believed that the short chain alkyl polyglucoside can potentiate the alpha hydroxy acid and deliver better antibacterial product efficacy. Additionally, while short chain alkylpolyglucoside in absence of the alcohol ethoxylate nonionic surfactant (Comparative Example 2) can provide good initial suds, good suds mileage and effective AB log kill, it has been found that short chain alkyl polyglucoside surfactant alone does not solubilize perfumes/fragrances as well as the alcohol ethoxylate nonionic surfactant. As such, formulations lacking the alcohol ethoxylate nonionic surfactant may not be able to provide physically stable formulations and as such deliver a good scent experience for a user.

TABLE 4

| | Initial | 10 minutes | AB |
|---|---|---|---|
| | Suds | remaining suds | log |
| Composition | (ml/g) | (ml/g) | kill |
| Inventive Ex. 1 | 26.0 | 12.0 | 4.7 |
| Comparative Ex. 1 | 25.0 | 5.7 | 1.7 |
| Comparative Ex. 2 | 23.6 | 15.7 | 5.3 |
| Comparative Ex. 3 | 18.2 | 7.0 | 0.6 |
| Comparative Ex. 4 | 2.1 | 0.3 | 2.1 |
| Comparative Ex. 5 | 5.8 | 0.0 | 0.5 |
| Comparative Ex. 6 | 22.3 | 17.3 | 2.0 |
| Comparative Ex. 7 | 8.6 | 7.1 | 0.8 |
| Comparative Ex. 8 | 5.7 | 3.3 | 1.0 |
| Comparative Ex. 9 | 5.7 | 4.2 | 0.6 |

### Methods

### A) Viscosity:

The rheology profile is measured using a “TA instruments DHR1” rheometer, using a cone and plate geometry with a flat steel Peltier plate and a 60 mm diameter, 2.0260 cone (TA instruments, serial number: SN960912). The viscosity measurement procedure includes a conditioning step and a sweep step at 20′° C. The conditioning step consists of a 10 seconds at zero shear at 20° C., followed by pre-shearing for 10 seconds at 10 s⁻¹ at 20° C., followed by 30 seconds at zero shear at 20° C. in order for the sample to equilibrate. The sweep step comprises a logarithmical shear rate increase in log steps starting from 0.01 s⁻¹ to 3,000 s⁻¹ at 20° C., with a 10 points per decade acquisition rate taken in a sample period of 15 s, after a maximum equilibration time of 200 seconds (determined by the rheometer, based on a set tolerance of 3%). When measuring shear thinning product compositions, the high shear viscosity is defined at a shear rate of 1,000 s⁻¹ and the low shear viscosity at a shear rate of 0.1 s⁻¹. For Newtonian product compositions the shear rate is recorded at 1,000 s⁻¹.

### b) Sudsing Performance

A graduated plastic beaker cone (500 ml capacity—available from Kartell LabWare) has been used to measure the amount of initial foam generated upon spraying, as well as to assess the remaining foam volume after 10 minutes. Hereto a spray bottle is used to spray 10 times to the center of the cone holding it at a 450 angle. The same spray bottle filled to the same target fill level is used across test products. The spray bottle has been sprayed 5 times outside the cone prior to initiating the test in order to ensure the spray engine and diptube are saturated with product. The amount of foam sprayed is read manually straight after spraying from the graduated scale, subtracting the liquid fraction at the bottom of the cone. The amount of remaining foam, again after subtraction of the liquid fraction at the bottom of the cone, is re-measured after 10 minutes. The amount of product sprayed is also measured by placing the product comprising cone on a scale and subtracting the weight of the empty cone itself. The amount of foam divided by the product weight value (ml/g) is calculated and the average of three test replicates is reported. In case of an uneven foam top surface the average of the foam height across the top cross plane is taken.

### C) Antibacterial Log Kill

AB log kill is the measure of the bacteria killed on a surface.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm”.

Every document cited herein, including any cross referenced or related patent or application and any patent application or patent to which this application claims priority or benefit thereof, is hereby incorporated herein by reference in its entirety unless expressly excluded or otherwise limited. The citation of any document is not an admission that it is prior art with respect to any disclosure disclosed or claimed herein or that it alone, or in any combination with any other reference or references, teaches, suggests or discloses any such disclosure. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

It is noted that one or more of the following claims utilize the term “where” or “in which” as a transitional phrase. For the purposes of defining the present technology, it is noted that this term is introduced in the claims as an open-ended transitional phrase that is used to introduce a recitation of a series of characteristics of the structure and should be interpreted in like manner as the more commonly used open-ended preamble term “comprising.” For the purposes of defining the present technology, the transitional phrase “consisting of” may be introduced in the claims as a closed preamble term limiting the scope of the claims to the recited components or steps and any naturally occurring impurities. For the purposes of defining the present technology, the transitional phrase “consisting essentially of” may be introduced in the claims to limit the scope of one or more claims to the recited elements, components, materials, or method steps as well as any non-recited elements, components, materials, or method steps that do not materially affect the novel characteristics of the claimed subject matter. The transitional phrases “consisting of” and 5 “consisting essentially of” may be interpreted to be subsets of the open-ended transitional phrases, such as “comprising” and “including,” such that any use of an open ended phrase to introduce a recitation of a series of elements, components, materials, or steps should be interpreted to also disclose recitation of the series of elements, components, materials, or steps using the closed terms “consisting of” and “consisting essentially of” For example, the recitation of a composition “comprising” components A, B, and C should be interpreted as also disclosing a composition “consisting of” components A, B, and C as well as a composition “consisting essentially of” components A, B, and C. Any quantitative value expressed in the present application may be considered to include open-ended embodiments consistent with the transitional phrases “comprising” or “including” as well as closed or partially closed embodiments consistent with the transitional phrases “consisting of” and “consisting essentially of”.

As used in the Specification and appended Claims, the singular forms “a”, “an”, and “the” include plural references unless the context clearly indicates otherwise. The verb “comprises” and its conjugated forms should be interpreted as referring to elements, components or steps in a non-exclusive manner. The referenced elements, components or steps may be present, utilized or combined with other elements, components or steps not expressly referenced.

It should be understood that any two quantitative values assigned to a property may constitute a range of that property, and all combinations of ranges formed from all stated quantitative values of a given property are contemplated in this disclosure. The subject matter of the present disclosure has been described in detail and by reference to specific embodiments. It should be understood that any detailed description of a component or feature of an embodiment does not necessarily imply that the component or feature is essential to the particular embodiment or to any other embodiment.

It should be apparent to those skilled in the art that various modifications and variations may be made to the embodiments described within without departing from the spirit and scope of the claimed subject matter. Thus, it is intended that the specification cover the modifications and variations of the various embodiments described within provided such modifications and variations come within the scope of the appended claims and their equivalents. Unless otherwise stated within the application, all tests, properties, and experiments are conducted at room temperature and atmospheric pressure.

What is claimed is:

1. A cleaning composition comprising:
from 2 to 20 wt. % of a surfactant system by weight of the cleaning composition, the surfactant system comprising:
alkyl polyglucoside surfactant,
a co-surfactant comprising an ethoxylated alcohol, and
less than 3 wt. % of anionic surfactant by weight of the cleaning composition; and
from 0.1 to 10 wt. % of an alpha hydroxy acid by weight of the cleaning composition, wherein:
the pH of the cleaning composition is less than 6.

2. The cleaning composition according to claim 1, wherein the pH of the cleaning composition ranges from 1 to 5.

3. The cleaning composition of claim 1, wherein the pH of the cleaning composition ranges from 1 to 3.

4. The cleaning composition of claim 1, comprising from 2 to 15 wt. % of the surfactant system by weight of the cleaning composition.

5. The cleaning composition of claim 1, comprising from 3 to 10 wt. % of the surfactant system by weight of the cleaning composition.

6. The cleaning composition of claim 1, comprising from 0.5 to 10 wt. % alkyl polyglucoside by weight of the cleaning composition.

7. The cleaning composition of claim 1, comprising from 1 to 5 wt. % alkyl polyglucoside by weight of the cleaning composition.

8. The cleaning composition of claim 1, wherein the alkyl polyglucoside surfactant comprises an alkyl chain length distribution of C8 to C16 and has a number average degree of polymerization of from 0.1 to 3.0.

9. The cleaning composition of claim 1, wherein the alkyl polyglucoside surfactant comprises an alkyl chain having a number average alkyl chain length of C8 to C10 and has a number average degree of polymerization of from 1.2 to 1.6.

10. The cleaning composition of claim 1, further comprising from 0.1 to 10 wt. % organic solvent by weight of the cleaning composition, wherein the organic solvent is selected from the group consisting of alcohols, glycols, glycol ethers, or combinations thereof.

11. The cleaning composition of claim 1, wherein the surfactant system comprises from 0.01 to 1 wt. % anionic surfactant by weight of the cleaning composition.

12. The cleaning composition of claim 1, wherein the ethoxylated alcohol has a number average alkyl chain of C4 to C8 and has a number average degree of ethoxylation ranging from 3 to 7.

13. The cleaning composition of claim 1, wherein the ethoxylated alcohol comprises linear hexyl ethoxylate having a number average degree of ethoxylation ranging from 5 to 6.

14. The cleaning composition of claim 1, comprising from 0.5 to 10 wt. % of the ethoxylated alcohol co-surfactant by weight of the cleaning composition.

15. The cleaning composition of claim 1, comprising from 1.0 to 5 wt. % of the ethoxylated alcohol co-surfactant by weight of the cleaning composition.

16. The cleaning composition of claim 1, wherein the surfactant system comprises less than 0.5 wt. % by weight of the cleaning composition of amphoteric surfactants, zwitterionic surfactants, cationic surfactant, or combinations thereof

17. The cleaning composition of claim 1, comprising from 1 to 10 wt. % alpha hydroxy acid by weight of the cleaning composition.

18. The cleaning composition of claim 1, comprising from 2 to 8 wt. % alpha hydroxy acid by weight of the cleaning composition, wherein the alpha hydroxy acid has a number average alkyl chain length of C3 to C6.

19. The cleaning composition of claim 1, wherein the alpha hydroxy acid is selected from the group consisting of citric acid, lactic acid, and combinations thereof.

20. A method of cleaning dishware using the cleaning composition of claim 1, comprising the steps of:
a) optionally pre-wetting the dishware;
b) spraying the cleaning composition onto the dishware;
c) optionally scrubbing the dishware; and
d) rinsing the dishware.
